(19) United States
(12) Patent Application Publication
(10) Pub. No.: US 2022/0070213 A1
(43) Pub. Date: Mar. 3, 2022

(54) METHOD AND SYSTEM FOR PREVENTING CSRF ATTACK ON WEBSITES USING FIRST PRIORITY ACTIVE SESSION

(71) Applicant: ARRIS Enterprises LLC, Suwanee, GA (US)

(72) Inventors: Harsha Bompalli Mutt, Karnataka (IN); Dileep Kumar Kotha, Karnataka (IN)

(21) Appl. No.: 17/359,958

(22) Filed: Jun. 28, 2021

Related U.S. Application Data
(60) Provisional application No. 63/070,001, filed on Aug. 25, 2020.

(51) Int. Cl. H04L 29/06; H04L 29/08

(52) U.S. Cl. CPC H04L 63/1483; H04L 63/1416; H04L 67/02; H04L 63/101; H04L 63/20; H04L 63/1425

(57) ABSTRACT

A method and system for preventing attacks on websites, and more particularly for preventing a Cross Site Request Forgery (CSRF) attack on a website served from a web server. The method includes receiving a login request and login credentials of a user of the website served from the web server of a network connected device, determining whether an HTTP Session exists for the user, initiating, by the web server, a logged in HTTP Session when there is no existing HTTP Session for the user, receiving an HTTP request on behalf of the user from a session other than the logged in HTTP Session, determining whether the logged in HTTP Session is active, and denying the HTTP request on behalf of the user from the session other than the logged in HTTP Session if the logged in HTTP Session is active.

### CROSS-REFERENCE TO RELATED APPLICATION

The present application claims priority to U.S. Provisional Patent Application Ser. No. 63/070,001, filed Aug. 25, 2020, the entire content of which is incorporated herein by reference as if set forth fully herein.

### TECHNICAL FIELD

The present disclosure generally relates to a method and system for preventing attacks on websites, and more particularly for preventing a Cross Site Request Forgery (CSRF) attack on a website served from a web server of a network connected device by initiating a logged in HTTP Session in response to receiving a login request and login credentials of the user, and denying an HTTP request on behalf of the user from a session other than the logged in HTTP Session if the logged in HTTP Session is active.

### BACKGROUND

Cable service providers, which are also referred to as Multiple System Operators (MSOs), or any communication or content distribution business that operates through a cable or broadband network, render their services to their subscribers. The services can include, but are not limited to, different subscription plans for broadband Internet access and telephony. In order to consume these services, subscribers connect to a private network owned (or co-owned or rented) by the broadband cable operator which is implemented according to the Data Over Cable Service Interface Specification (DOCSIS) standard.

Subscribers connect their computers, routers, voice-over-IP telephones and other devices to this network through network terminals (for example, cable modems (CMs) or network gateways), which are also known generally as customer-premises equipment (CPE). CPE may include customer-provided equipment as well as equipment furnished to the subscriber by the service provider. The network terminals include hardware which runs software that provides the low-level control for the device's specific hardware, which is known as firmware, which can be updated by pushing a new firmware version (or image) from time to time to the network gateway.

The network terminals may include as part of their firmware web server software that serves a website including web pages allowing a user to configure different parameters of the network terminal. In view of the ability to configure parameters of the network terminal, the security of the web server and access to its web pages may be important, and it may be advantageous to use various techniques to increase security.

Various types of malicious attacks can be made against web servers and the websites they serve, and in particular attacks that take advantage of a user's current login status or otherwise authenticated status. One such attack is a CSRF attack. In a CSRF attack, the attacker relies on the fact that a user is logged into or otherwise authenticated at a particular website. The attack involves running malicious code that relies on the logged in or otherwise authenticated status of the user at the particular website. In relying on the logged in or otherwise authenticated status of the user, a CSRF attack involves sending malicious requests to the web server, website, or web application, where the malicious requests are trusted based on the user's status, and are executed based on that status. As a result, such a malicious request can execute actions that are not intended by the user.

Several techniques exist to avoid CSRF attacks. The following disclosure is applicable to the Hypertext Transfer Protocol (HTTP) and Hypertext Transfer Protocol Secure (HTTPS) protocols, and references to HTTP herein should be understood to apply to use of HTTP or HTTPS. One technique relies on the Referrer Header of an HTTP request to verify the source of a request. However, there are numerous instances where a Referrer Header is not sent with an HTTP request, such as when a proxy server in between the requesting browser and the web server causes the Referrer Header to not be sent. Further, it is known that the Referrer Header can be spoofed or faked in an HTTP request, making it an unreliable way to detect malicious activity. Another class of techniques involve the use of validation tokens. However, such techniques involve the need to organize and manage such validation tokens. Another class of techniques involve the use of custom HTTP headers with requests. However, that class of techniques involves the need to consistently use such custom HTTP headers, which limits site design. Another class of techniques involve modifying underlying web browsers, which limits universal application of such techniques to standard web browsers.

Thus, while there are techniques available to avoid CSRF attacks, a simpler and more straightforward technique is needed, and particularly for use with CMs or gateways.

### SUMMARY

In accordance with exemplary embodiments, it would be desirable to have a method and system for preventing attacks on websites, and more particularly for preventing a Cross Site Request Forgery (CSRF) attack on a website served from a web server.

In accordance with an aspect, a method of preventing a CSRF attack on a website served from a web server of a network connected device is provided, the method comprising: receiving a login request and login credentials of a user of the website served from the web server of the network connected device, wherein the website comprises web pages, determining whether an HTTP Session exists for the user, initiating, by the web server, a logged in HTTP Session in response to receiving the login request and the login credentials of the user when there is no existing HTTP Session for the user, receiving an HTTP request on behalf of the user from a session other than the logged in HTTP Session, determining whether the logged in HTTP Session is active, and denying the HTTP request on behalf of the user from the session other than the logged in HTTP Session if the logged in HTTP Session is active, wherein following the denial of the HTTP request the logged in HTTP Session remains active.

In accordance with another aspect, a network connected device configured to prevent a CSRF attack on a website served from a web server of the network connected device is provided, that includes a processor configured to: receive a login request and login credentials of a user of the website served from the web server of the network connected device, wherein the website comprises web pages, determine whether an HTTP Session exists for the user, initiate, by the web server, an HTTP Session in response to receiving the login request and the login credentials of the user when there is no existing HTTP Session for the user, receive an HTTP request on behalf of the user from a session other than the logged in HTTP Session, determine whether the logged in HTTP Session is active, and deny the HTTP request on behalf of the user from the session other than the logged in HTTP Session if the logged in HTTP Session is active, wherein following the denial of the HTTP request the logged in HTTP Session remains active.

### BRIEF DESCRIPTION OF THE DRAWING

FIG. 1 is an illustration of an exemplary network environment for a method and system for preventing CSRF attack on websites using first priority active session.

FIG. 2 is a flowchart illustrating an exemplary embodiment of preventing CSRF attack on a website using first priority active session.

FIG. 3 is an illustration of an exemplary embodiment message flow of establishing a logged in HTTP Session in response to receiving a login request and login credentials of a user when there is no existing HTTP Session for the user.

FIG. 4 is an illustration of an exemplary embodiment message flow of denying an HTTP request on behalf a user from a session other than a logged in HTTP Session.

FIG. 5 is an illustration of an exemplary embodiment of multiple HTTP Clients attempting to log into a web server configured in accordance with the present disclosure.

FIG. 6 is an illustration of a user interface of a web page of a website served by a web server of a network connected device.

FIG. 7 is an illustration of a user interface of a web page of a website served by a web server of a network connected device displaying a message indicating that a login request has been denied.

FIG. 8 is an exemplary hardware architecture for an embodiment of a network connected device.

### DETAILED DESCRIPTION

### System for Preventing CSRF Attack on Websites Using First Priority Active Session

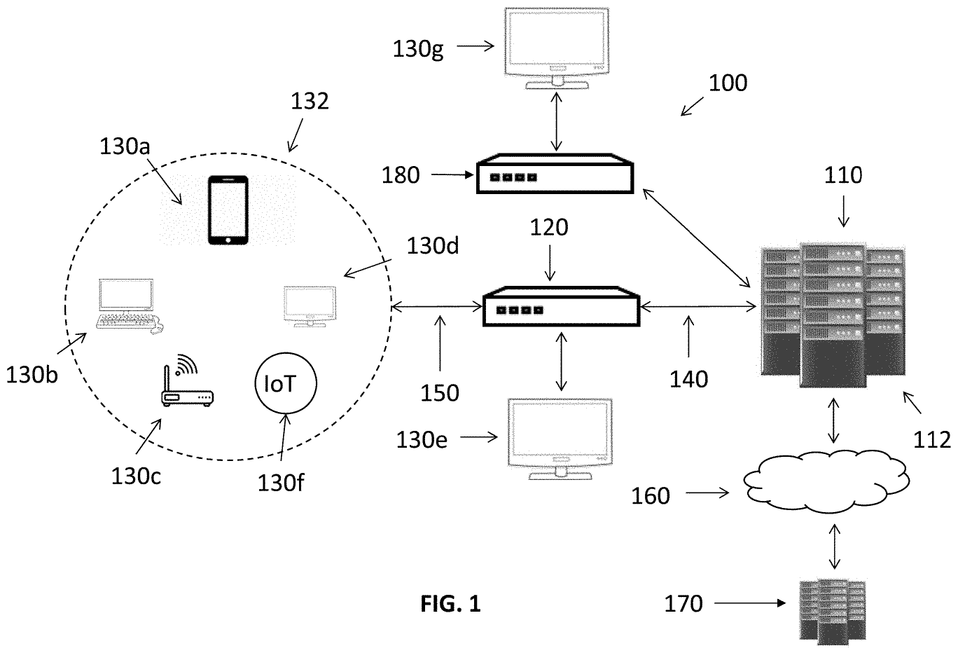

FIG. 1 is a block diagram illustrating an example network environment 100 operable for CPE broadband devices 120. In accordance with an exemplary embodiment, the CPE broadband device 120 can include, for example, a network gateway in the form of a modem/router/MTA device configured to provide voice, data, and video services. In embodiments, the CPE broadband device 120 can provide, for example, video and/or data services to a plurality of devices 130a, 130b, 130c, 130d, 130e, 130f. The CPE broadband device 120 may communicate with the plurality of devices 130a, 130b, 130c, 130d, 130f over a local network 132 (for example, a local area network (LAN), a wireless local area network (WLAN), a personal area network (PAN), etc.) through a connection 150, and may communicate with an upstream wide area network (WAN) 160 through a connection 140 to a cable provider system 110, such as a headend or cable modem termination system (CMTS). The CPE broadband device 120 may also be wired directly to a device, for example, a television 130e connected to an aspect of CPE broadband device 120 as a set top box (STB). As another example, an Internet of Things (IoT) device 130f may also communicate with an upstream wide area network (WAN) 160 over a local network 132 through CPE broadband device 120 and through a connection 140 to a cable provider system 110. In another embodiment, CPE 180 is a set top box (STB), and communicates with television 130g to provide video services. The connected devices 130a, 130b, 130c, 130d, 130e, 130f, 130g connected to the CPE broadband device 120, or CPE 180 are embodiments of network connected devices. CPE broadband device 120 and CPE 180 are also embodiments of network connected devices.

Any of these network connected devices may be configured to function as a web server that serves a website, and security of that web server and website may be important. Embodiments of this disclosure are applicable to any network connected device that functions as a web server and serves a website, or any web server implementing sessions with the HTTP or HTTPS protocols. References to HTTP herein should be understood to apply to use of HTTP or HTTPS. For example, CPE broadband device 120 may include a website served on a web server. That website of CPE broadband device 120 may comprise web pages to configure at least one parameter of CPE broadband device 120. For example, the at least one parameter of CPE broadband device 120 may be an access control parameter to identify another network connected device that is granted or denied access to CPE broadband device 120. This type of configuration may be called a black list or a white list. In another embodiment, the at least one parameter of CPE broadband device 120 indicates the quality of service that CPE broadband device 120 provides to another network connected device. For example, CPE broadband device 120 may be configured to provide a higher quality of service to a network connected device configured to serve as a work at home computer, whereas CPE broadband device 120 may be configured to provide a lower quality of service to an IoT Smart Doorbell system. As yet another example, the at least one parameter may be a quality of service parameter associated with a type of network traffic. In such an embodiment, CPE broadband device 120 may be configured to provide a higher quality of service to network traffic associated with work from applications or computers, whereas CPE broadband device 120 may be configured to provide a lower quality of service to network traffic associated with IoT Smart Home devices.

The cable provider system 110 can provide high-bandwidth data transfer, for example, cable television and broadband internet access via, for example, coaxial cables 140. The cable provider system 110 can include one or more servers 112 configured to deliver services, for example, cable television and/or broadband internet and infrastructure supporting such services including management of image software and/or firmware. One or more servers 112 are embodiments of computing devices of a service provider such as an MSO. Other servers 170 or resources 170 are accessible via WAN 160.

In accordance with an exemplary embodiment, the CPE broadband device 120 and the plurality of devices 130a, 130b, 130c, 130d, 130e, 130f can be configured to connect via a wireless network, for example, wireless network utilizing an IEEE 802.11 specification, including a set-top box (STB), a smart phone, a smart TV, a computer, a mobile device, a tablet, a router, a home security system, an IoT device, or any other device operable to communicate wirelessly with the CPE broadband device 120. The CPE broadband device 120 may provide access to an external network, such as the Internet, for any devices connected thereto via the area network 132. The area network 132 may be, for instance a local area. In accordance with an exemplary embodiment, the CPE broadband device 120 may be a gateway device, an access point, a modem, a wireless router including an embedded modem, a wireless network extender or any other device operable to deliver, for example, data and/or video services from the cable provider system 110 and/or a WAN 160 to one or more of the plurality of devices 130a, 130b, 130c, 130d, 130e, 130f.

In accordance with an exemplary embodiment, the CPE broadband device 120 may communicate with the provider system 110 over a wired or a wireless connection. A wireless connection between the provider system 110 and the CPE broadband device 120 may be established through a protected setup sequence (for example, Wi-Fi protected setup (WPS)). The protected setup sequence may include the steps of scanning multiple wireless channels for an available access point, exchanging one or more messages between a station and access point, exchanging key messages (for example, pre-shared key (PSK)) between the station and access point, and installing a key (for example, PSK) at the station.

### Process for Preventing CSRF Attack on Websites Using First Priority Active Session

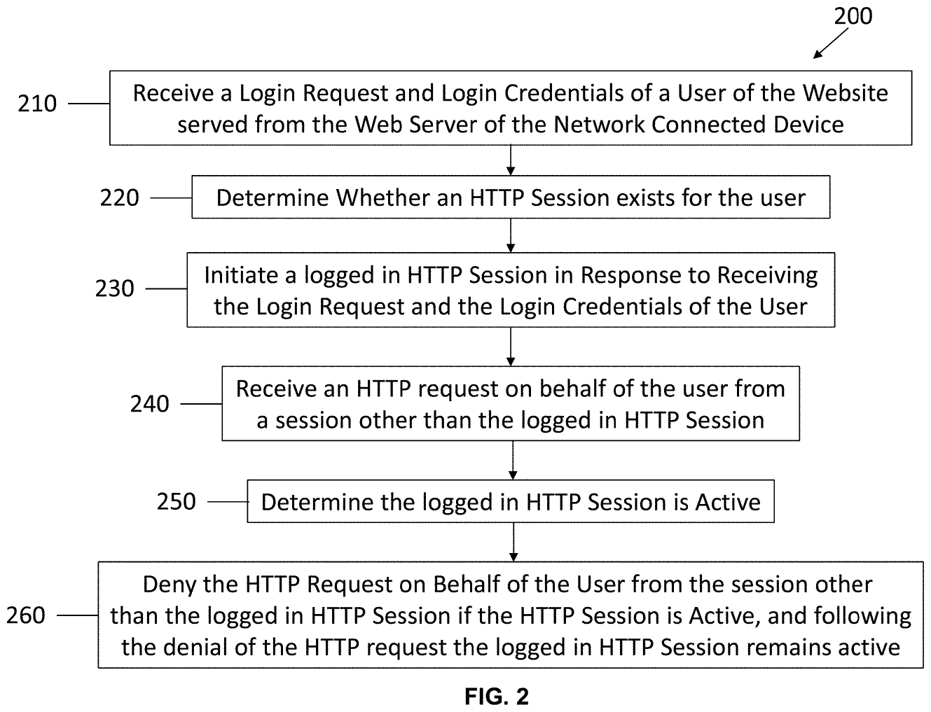

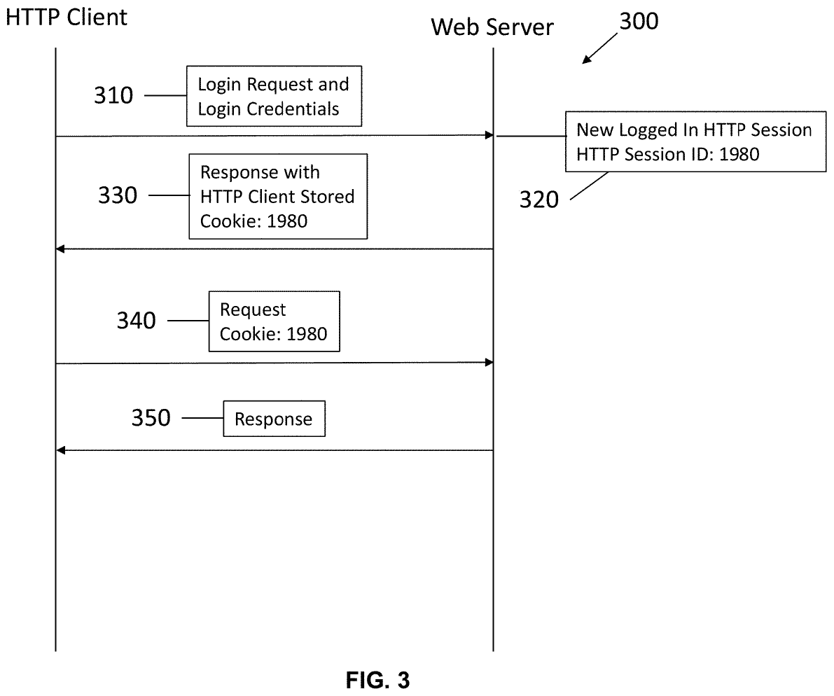

FIG. 2 is a flowchart 200 illustrating an exemplary embodiment of preventing CSRF attack on a website using first priority active session. In the embodiment of FIG. 2, the network connected device includes a web server that serves a website, for example, as discussed above. As shown in FIG. 2, the process starts in step 210. In step 210, the network connected device receives a login request and login credentials of a user of the website served from the web server. Following step 210, in step 220 the web server of the network connected device determines whether there is an HTTP Session for the User, and in step 230 initiates a logged in HTTP Session in response to receiving the login request and the login credentials of the user when there is no existing HTTP Session for the user. In this regard, reference is made to FIG. 3.

FIG. 3 is an illustration of an exemplary embodiment message flow 300 of establishing a logged in HTTP Session in response to receiving a login request and login credentials of a user when there is no existing HTTP Session for the user. In message 310, a login request and login credentials of a user of the website served by the web server of the network connected device is received from an HTTP Client. In certain embodiments, the HTTP client is a web browser. In response to receiving message 310, the web server of the network connected device determines whether an HTTP Session exists for the user. In some embodiments, determining whether an HTTP Session exists for the user includes checking a session count for the user, and determining whether there is an existing HTTP Session for the user if the session count is greater than zero. In such an embodiment, the session count may be set to zero when the user is logged out by either user action or a timeout. In other embodiments, determining whether an HTTP Session exists for the User includes checking for data in a user session data structure, and determining whether there is an existing HTTP Session for the user if the user session data structure includes user data. In such an embodiment, the user data of the user session data structure may be deleted when the user is logged out by either user action or a timeout. When there is no existing HTTP Session for the user, the web server creates new logged in HTTP Session 320 with the Session ID 1980. In the exemplary embodiment of FIG. 3, certain information regarding logged in HTTP Session 320 is stored in a cookie which is sent back to the HTTP Client as a response message 330. Thereafter, the HTTP Client may send a further request 340 within the logged in HTTP Session 320 with Session ID 1980, by providing information stored in the cookie the web server created for Session 320. In response, the web server will send a response 350. Other HTTP Session handling techniques may also apply to the embodiment illustrated in FIG. 3, including varying information stored at the HTTP Client end and the Web server end, and with or without use of cookies stored at the HTTP Client end.

Turning back to FIG. 2, following the initiation of a logged in HTTP Session, as described for example with reference to FIG. 3, in step 240 an HTTP request on behalf of the user from a session other than the logged in HTTP Session is received. Following step 240, step 250 determines whether the logged in HTTP Session that was initiated in response to receiving the login request and login credentials is active. In some embodiments, determining whether the HTTP logged in session is active includes checking a session count for the user, and determining whether the logged in HTTP Session is active if the session count is greater than zero. In such an embodiment, the session count may be set to zero when the user is logged out by either user action or a timeout. In other embodiments, determining whether the logged in HTTP Session is active includes checking for data in a user session data structure, and determining whether the logged in HTTP Session is active if the user session data structure includes user data. In such an embodiment, the user data of the user session data structure may be deleted when the user is logged out by either user action or a timeout.

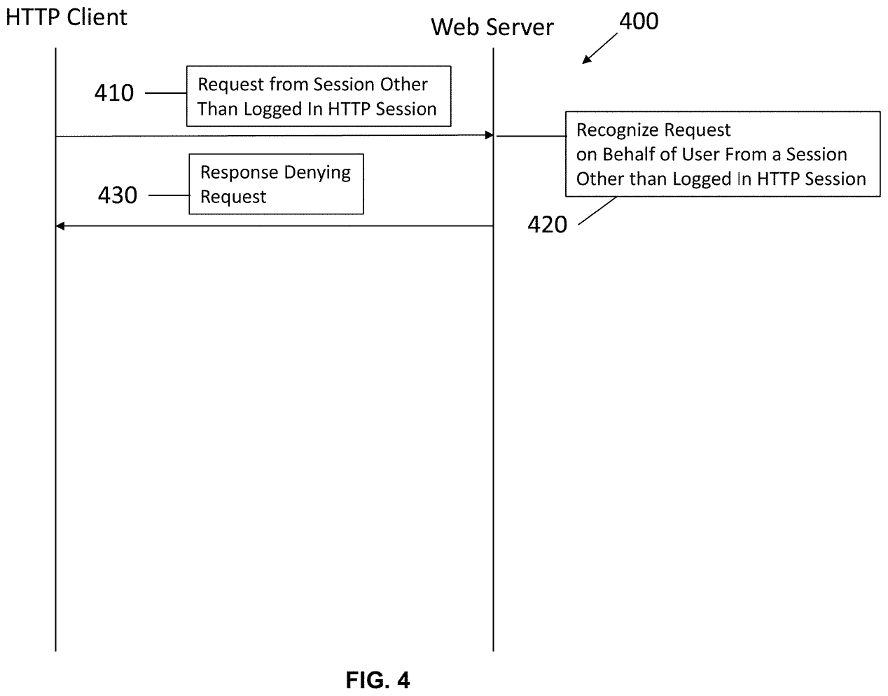

Following step 250, at step 260 the HTTP request on behalf of the user from the session other than the logged in HTTP Session is denied if the logged in HTTP Session is active, and following the denial of the HTTP request the logged in HTTP Session remains active. In such an embodiment, following denial of the HTTP request on behalf of the user from the session other than the logged in HTTP Session, the user may continue accessing the website served from the web server of the network connected device using the logged in HTTP Session that is active. In this regard, reference is made to FIG. 4.

FIG. 4 is an illustration of an exemplary embodiment message flow 400 of denying an HTTP request on behalf a user from a session other than a logged in HTTP Session. In message 410, an HTTP request is received from a session other than the logged in HTTP Session initiated in response to receiving the login request and user credentials, for example, logged in HTTP Session 320 of FIG. 3. In some embodiments, the HTTP request received from the session other than the logged in HTTP Session is a request to login to the website served from the web server of the network connected device. In response, the web server recognizes the HTTP request as one from a session other than the logged in HTTP Session, and if the logged in HTTP Session is active, it denies the request and sends a response 430 denying the request.

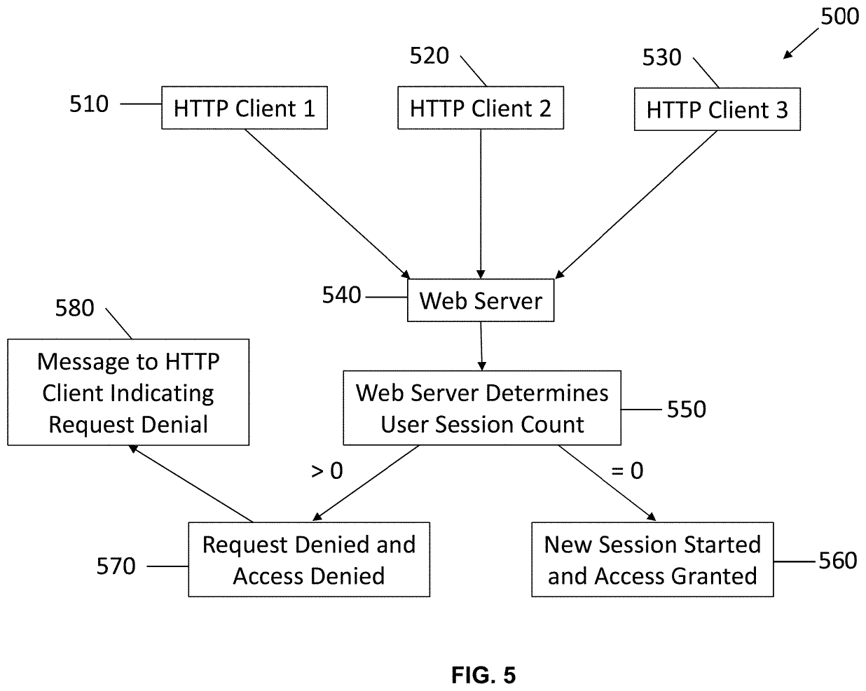

FIG. 5 is an illustration 500 of an exemplary embodiment of multiple HTTP Clients attempting to log into a website served on a web server 540 configured in accordance with embodiments of the present disclosure. As illustrated in FIG. 5, there are three HTTP Clients 510, 520, and 530. In the following explanation of an embodiment of the disclosure of FIG. 5, the HTTP Clients 510, 520, and 530 are web browsers of individual computers. Numerous scenarios of interaction with a website served from web server 540 are illustrated in FIG. 5. For example, in the instance where HTTP Client 1 510 attempts to access the website served from web server 540 with a login request and login credentials of a user, the web server 540 may determine the current user session count 550. If the current user session count for the user that has requested access from HTTP Client 1 510 is equal to zero, then there is no existing session for that user, a new logged in HTTP Session is initiated, a session count for that user is incremented to one (1), and access to the website served from the web server is granted 560.

As a further example, HTTP Client 2 520 may also now attempt to login to the website served from web server 540 using the same user login credentials and a login request as an HTTP request. In the example embodiment of FIG. 5, such a request from HTTP Client 520 is from a session other than the logged in HTTP Session initiated between HTTP Client 1 510 and web server 540 because the request is sent from HTTP Client 2 520, which is a different web browser on a different computer compared to HTTP Client 1 510. In such an example, the request from HTTP Client 520 is an HTTP request on behalf of the user from the session other than the logged in HTTP Session initiated between HTTP Client 1 510 and web server 540. Upon receipt of the login request and login credentials of the user from HTTP Client 2 520, web server 540 may determine the current user session count 550 is greater than zero, because of the logged in HTTP Session initiated by HTTP Client 1 510, and the web server denies the request from HTTP Client 2 520 and access is denied 570. In some embodiments, the denial of the request from HTTP Client 2 520 includes providing a message to HTTP Client 2 520 indicating the denial of the request 580. In the present explanation of an embodiment of the disclosure of FIG. 5, HTTP Client 2 520 is a web browser on an individual computer, and the denial of the request from HTTP Client 2 520 includes providing a message to the web browser source (HTTP Client 2 520) of the HTTP request indicating the HTTP request was denied.

In another example in consideration of FIG. 5, before HTTP Client 2 520 attempts to login to the website served from web server 540 using the same user login credentials and a login request as an HTTP request, the user is logged out of the website served by web server 540 at HTTP Client 1 510 either by user action or by a timeout. When the user is logged out of the website served from web server 540 at HTTP Client 1 510, the session count is set to zero. Thereafter, in this example, HTTP Client 2 520 attempts to login to the website served from web server 540 using the same user login credentials and a login request. In this scenario, the web server 540 may determine the current user session count 550 is zero, meaning there is no existing session for that user, a new logged in HTTP Session is initiated, a session count for that user is incremented to one (1), and access to the website served from the web server is granted 560.

Other embodiments are also contemplated by the disclosure of FIG. 5. For instance, each of HTTP Clients 1, 2, 3 (510, 520, 530) may be individual browser window instances on the same computer, where requests from any of HTTP Clients 2 and 3 may be considered from a session other than any session established between a HTTP Client 1 and web server 540. Likewise, requests from any of HTTP Clients 1 and 3 may be considered from a session other than any session established between HTTP Client 2 and web server 540, and requests from any of HTTP Clients 1 and 2 may be considered from a session other than any session established between HTTP Client 3 and web server 540. In some embodiments where HTTP Clients 1, 2, 3 (510, 520, 530) may be individual browser window instances on the same computer, the browser software is the same. In other embodiments where HTTP Clients 1, 2, 3 (510, 520, 530) may be individual browser window instances on the same computer, the browser software is different. For Example, HTTP Client 1 may be an individual browser window instance of Chrome, HTTP Client 2 may be an individual browser window instance of Microsoft Explorer, and HTTP Client 3 may be an individual browser window instance of Firefox.

In another embodiment contemplated by FIG. 5, each of HTTP Clients 1, 2, 3 (510, 520, 530) may be individual browser tabs on the same computer within the same web browser, where requests from any of HTTP Clients 2 and 3 may be considered from a session other than any session established between a HTTP Client 1 and web server 540. Likewise, requests from any of HTTP Clients 1 and 3 may be considered from a session other than any session established between HTTP Client 2 and web server 540, and requests from any of HTTP Clients 1 and 2 may be considered from a session other than any session established between HTTP Client 3 and web server 540.

In another embodiment contemplated by FIG. 5, HTTP Clients 1 and 2, are browser window instances or tabs within the same browser running on one computer, and HTTP Client 3 is a browser window instance running on another computer. In such an embodiment, requests from any of HTTP Clients 2 and 3 may be considered from a session other than any session established between a HTTP Client 1 and web server 540. Likewise, requests from any of HTTP Clients 1 and 3 may be considered from a session other than any session established between HTTP Client 2 and web server 540, and requests from any of HTTP Clients 1 and 2 may be considered from a session other than any session established between HTTP Client 3 and web server 540.

In other embodiments, HTTP Clients 1, 2, and 3 may be any combination of different browser window instances running on the same or different computers, different browser software, and tabs within the same browser, where requests from any of HTTP Clients 2 and 3 may be considered from a session other than any session established between a HTTP Client 1 and web server 540. Likewise, requests from any of HTTP Clients 1 and 3 may be considered from a session other than any session established between HTTP Client 2 and web server 540, and requests from any of HTTP Clients 1 and 2 may be considered from a session other than any session established between HTTP Client 3 and web server 540.

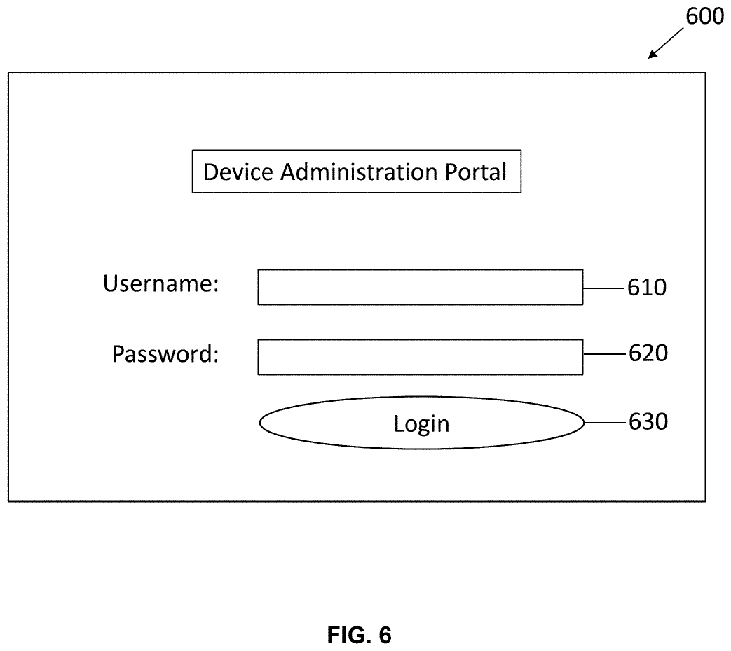

FIG. 6 is an illustration of a user interface 600 of a web page of a website served by a web server of a network connected device. The illustrated user interface 600 may be the login web page to access other web pages that allow a user to configure certain parameters of the network connected device as a Device Administration Portal. In the illustrated embodiment, user interface 600 includes a username field 610 where a username may be entered and a password field 620 where a password may be entered. In the illustrated embodiment, the username and password together are the login credentials of the user of the website served by the web server. In certain embodiments, once the username and password have been entered into fields 610 and 620, a login input 630 may be used to send a login request along with the login credentials of the user of the website to the web server of the network connected device. Thereafter, a user may be granted access to the website, as discussed for example in connection with the embodiments of FIG. 5, above.

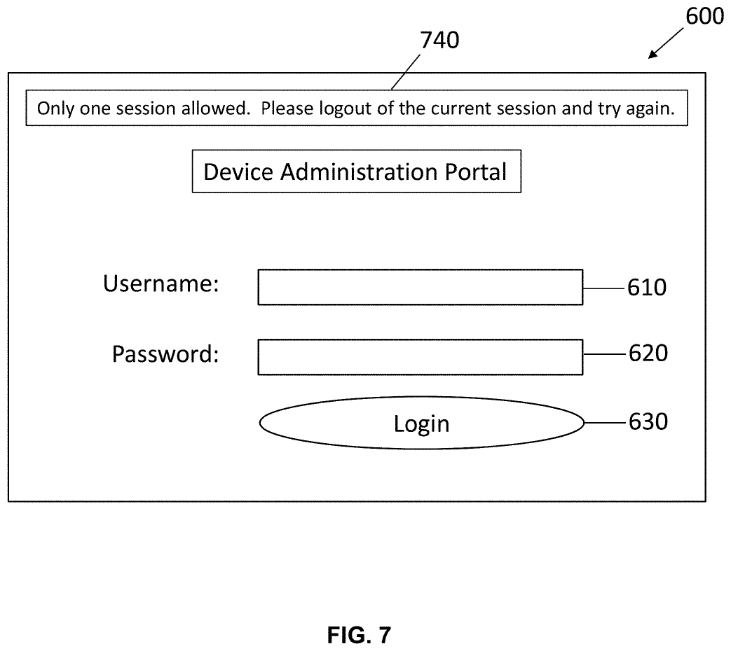

FIG. 7 is an illustration of a user interface 600 of a web page of a website served by a web server of a network connected device displaying a message indicating that a login request has been denied. In the embodiment of FIG. 7, for example, a login request is sent with the login credentials of the user, but there is already an existing session for the user as described for example in connection with the embodiments of FIG. 5, above. As shown in the embodiment of FIG. 7, the login request is denied by the web server and a message 740 is provided to the web browser source (user interface 600) of the login request indicating the request was denied which states “Only one session allowed. Please logout of the current session and try again.”

### Computer System Architecture

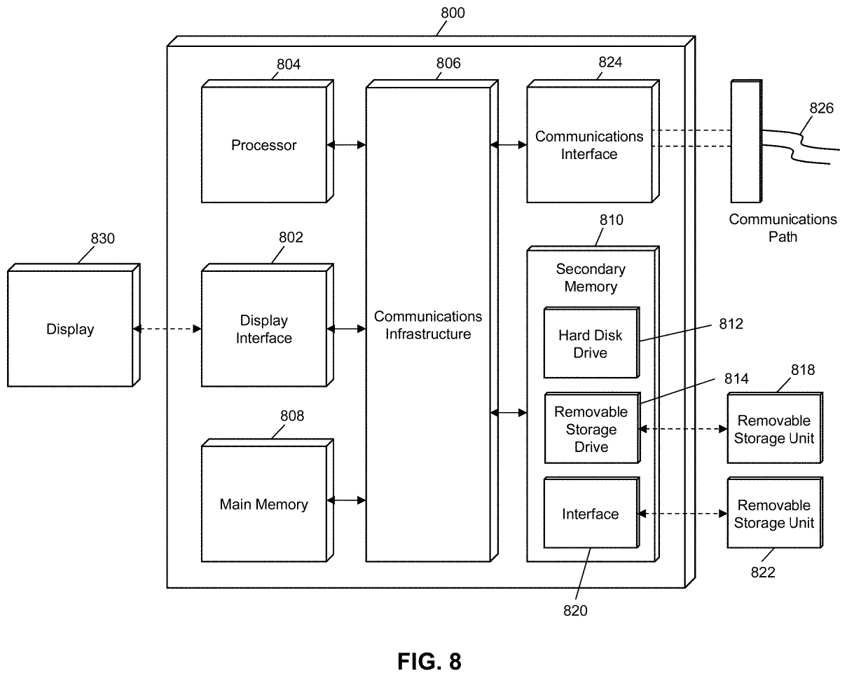

FIG. 8 illustrates a representative computer system 800 in which embodiments of the present disclosure, or portions thereof, may be implemented as computer-readable code executed on a processor of a computer. For example, the one or more servers 112, the CPE broadband device 120, CPE device 180, and the plurality of devices 130a, 130b, 130c, 130d, 130e, 130f, 130g of FIG. 1 may be implemented in whole or in part by a computer system 800 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the present disclosure.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this representative computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device specifically configured to perform the functions discussed herein. The processor device 804 may be connected to a communications infrastructure 806, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 1-7, as discussed herein. Accordingly, such computer programs may represent controllers of the computer system 800. Where the present disclosure is implemented using software executed on hardware, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software executed on hardware, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for preventing attacks on websites, and more particularly for preventing a CSRF attack on a web site served from a web server of a network connected device, which increases security of such websites, particularly in the circumstances where a network terminal includes as part of its firmware web server software that serves a website including web pages allowing a user to configure different parameters of the network terminal. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

That which is claimed is:

1. A method of preventing a Cross Site Request Forgery (CSRF) attack on a website served from a web server of a network connected device, the method comprising:
receiving a login request and login credentials of a user of the website served from the web server of the network connected device, wherein the website comprises web pages;
determining whether an HTTP Session exists for the user;
initiating, by the web server, a logged in HTTP Session in response to receiving the login request and the login credentials of the user when there is no existing HTTP Session for the user;
receiving an HTTP request on behalf of the user from a session other than the logged in HTTP Session;
determining whether the logged in HTTP Session is active; and
denying the HTTP request on behalf of the user from the session other than the logged in HTTP Session if the logged in HTTP Session is active, wherein following the denial of the HTTP request the logged in HTTP Session remains active.

2. The method of claim 1, wherein determining whether the logged in HTTP Session is active includes checking a session count for the user, and determining whether the logged in HTTP Session is active if the session count is greater than zero.

3. The method of claim 1, wherein determining whether the logged in HTTP Session is active includes checking for data in a user session data structure, and determining whether the logged in HTTP Session is active if the user session data structure includes user data.

4. The method of claim 2, wherein the session count is set to zero when the user is logged out by either user action or a timeout.

5. The method of claim 3, wherein the user data of the user session data structure is deleted when the user is logged out by either user action or a timeout.

6. The method of claim 1, wherein following denial of the HTTP request on behalf of the user from the session other than the logged in HTTP Session, the user may continue accessing the website served from the web server of the network connected device using the logged in HTTP Session that is active.

7. The method of claim 1, wherein the website comprises web pages to configure at least one parameter of the network connected device.

8. The method of claim 7, wherein the at least one parameter of the network connected device is an access control parameter to identify a second network connected device that is granted or denied access to the network connected device, or a quality of service control parameter to identify a quality of service that the network connected device provides to a third network connected device.

9. The method of claim 1, wherein denying the HTTP request on behalf of the user from the session other than the logged in HTTP Session includes providing a message to a web browser source of the HTTP request indicating the HTTP request was denied.

10. The method of claim 1, wherein the HTTP request on behalf of the user from the session other than the logged in HTTP Session is a request to login to the website served from the web server of the network connected device.

11. A network connected device configured to prevent a Cross Site Request Forgery (CSRF) attack on a website served from a web server of the network connected device, comprising:
a processor configured to:
receive a login request and login credentials of a user of the website served from the web server of the network connected device, wherein the website comprises web pages;
determine whether an HTTP Session exists for the user;
initiate, by the web server, a logged in HTTP Session in response to receiving the login request and the login credentials of the user when there is no existing HTTP Session for the user;
receive an HTTP request on behalf of the user from a session other than the logged in HTTP Session;
determine whether the logged in HTTP Session is active; and
deny the HTTP request on behalf of the user from the session other than the logged in HTTP Session if the logged in HTTP Session is active, wherein following the denial of the HTTP request the logged in HTTP Session remains active.

12. The network connected device of claim 11, wherein the processor is configured to:
determine whether the logged in HTTP Session is active by checking a session count for the user, and determining whether the logged in HTTP Session is active if the session count is greater than zero.

13. The network connected device of claim 11, wherein the processor is configured to:
determine whether the logged in HTTP Session is active by checking for data in a user session data structure, and determining whether the logged in HTTP Session is active if the user session data structure includes user data.

14. The network connected device of claim 12, wherein the session count is set to zero when the user is logged out by either user action or a timeout.

15. The network connected device of claim 13, wherein the user data of the user session data structure is deleted when the user is logged out by either user action or a timeout.

16. The network connected device of claim 11, wherein the website comprises web pages to configure at least one parameter of the network connected device.

17. The network connected device of claim 16, wherein the at least one parameter of the network connected device is an access control parameter to identify a second network connected device that is granted or denied access to the network connected device, or a quality of service control parameter to identify a quality of service that the network connected device provides to a third network connected device.

18. The network connected device of claim 11, wherein the processor is configured to:
provide a message to a web browser source of the HTTP request indicating the HTTP request was denied.

19. The network connected device of claim 11, wherein the HTTP request on behalf of the user from the session other than the logged in HTTP Session is a request to login to the website served from the web server of the network connected device.

20. A non-transitory computer readable medium having instructions operable to cause one or more processors of a network connected device configured to function as a web server that serves a website, to perform operations comprising:
receive a login request and login credentials of a user of the website served from the web server of the network connected device, wherein the website comprises web pages;
determine whether an HTTP Session exists for the user;
initiate, by the web server, a logged in HTTP Session in response to receiving the login request and the login credentials of the user when there is no existing HTTP Session for the user;
receive an HTTP request on behalf of the user from a session other than the logged in HTTP Session;
determine whether the logged in HTTP Session is active; and
deny the HTTP request on behalf of the user from the session other than the logged in HTTP Session if the logged in HTTP Session is active, wherein following the denial of the HTTP request the logged in HTTP Session remains active.
